(19) United States
(12) Patent Application Publication
(10) Pub. No.: US 2012/0045979 A1
(43) Pub. Date: Feb. 23, 2012

(54) Tool for Shelling Prawn or like Crustaceans

(76) Inventors: Roberto Capomazza, Napoli (IT); Giorgio Camino, Giugliano in Campania (NA) (IT)

(21) Appl. No.: 13/263,988

(22) PCT Filed: Apr. 14, 2010
(86) PCT No.: PCT/IB10/51624

§ 371 Date: Oct. 11, 2011

(30) Foreign Application Priority Data
Apr. 17, 2009 (IT) VI2009A000085

(51) Int. Cl. A22C 29/02

(52) U.S. Cl. 452/5; 452/1

(57) ABSTRACT

A tool for shelling crustaceans (C), in particular prawns, imperial prawns and the like. The tool (1) comprises a base element (2), which includes a seat (7) for inserting and blocking the crustacean, and a slider (3) slidably coupled with said base element (2) for sliding along a first predetermined direction (X). The slider comprises cutting means (14) susceptible to interact with the crustacean blocked in said seat for cutting the shell thereof during the sliding of the slider.

### FIELD OF THE INVENTION

The present invention relates to the field of the tools in general, and particularly relates to a tool for shelling crustaceans, such as prawns, imperial prawns or the like. Moreover, the present invention relates to a industrial line for working crustaceans which includes said tool.

### STATE OF THE ART

It is known that the shelling of crustaceans, such as prawns, imperial prawns or the like, is quite difficult, in particular if cutlery are used.

On the other hand, there are some situations where the use of cutlery is pretty uncomfortable, such as during grilling, festivals or the like. However, as known, the shelling of crustaceans by hand is unhygienic, as well as inevitably cause the dirtying thereof.

Further, industrially, the long times of the manual shelling of the crustaceans remarkably reduce the flow of the whole working process thereof.

It is a long felt need for a tool allowing for the shelling of crustaceans in a practical and fast manner, without touching the crustacean with hands and without getting dirty therewith.

### SUMMARY OF THE INVENTION

A general object of the present invention is to overcome at least partly the above drawbacks, by providing a tool which allows for the shelling of crustaceans in a practical and fast manner, without touching the crustacean with hands and without getting dirty therewith.

A particular object of the invention is to provide an industrial line for working crustaceans which allows for the maximum speeding up of the shelling thereof.

These objects, as well as other objects that will became apparent hereinafter, are fulfilled by a tool for shelling of crustaceans, such as prawns, imperial prawns and the like, having one or more of the features disclosed in the present document.

Advantageously, the tool may include a base element having a seat for inserting and blocking the crustacean and a slider coupled with the base element for sliding along a first longitudinal direction, which may be straight or curved.

The slider may include cutting means, susceptible to interact with the crustacean blocked in the seat for cutting the shell thereof during the sliding of the slider along the first direction. In this way, it is possible to shell the crustaceans in a practical and fast manner, without touching the crustacean with hands and without getting dirty therewith.

In this document, the term “cutting means” and derivatives thereof indicates one or more elements capable of interacting directly with a body for separating thereof into two or more portions.

Suitably, the slider may include extraction means, which can interact with the crustacean blocked in the seat to run through the meat thereof upon the cutting of the shell by the cutting means and, subsequently, to extract it.

The slider may be removably coupled with the base element, thereby enabling a user to access easily and comfortably to the crustacean. On the other hand, the removal of the meat of the prawn without touching it by hands is also possible, and further the possible movement and depositing thereof on a suitable support such as a plate.

Conveniently, the inner surface of the seat may be capable of receiving the back part of the crustacean, i.e. the part opposite to one where are the legs thereof.

The seat and the cutting means may be in a such reciprocal spaced relationship, i.e. they may have mutual distance and/or relative position, so as to define a cutting direction along the front part of the crustacean blocked in the seat, i.e. in correspondence of the legs.

The crustacean, once placed in the seat, due to the interaction with the slider will tend to slide within the same upon the action of the slider.

Therefore, means may be suitably provided for blocking the sliding of the crustacean and for firmly engaging thereof within the seat during the cutting of the shell. Preferably, the seat may include such blocking and fixing means, which can be at least partly defined by an appropriate configuration thereof.

Moreover, due to the interaction with the slider, the crustacean placed in the seat tends to move horizontally and/or rotate within the same under the action of the slider.

Conveniently, therefore, means may be provided for blocking the lateral movement and/or the rotation of the crustacean and the centering thereof within the seat during the cutting of the shell, in such a manner to bring it into line with the cutting means and to promote the action thereof. Preferably, the seat may include such centering means, which can be partially defined by an appropriate configuration thereof.

The tool, which may include one or more of the features described below, may advantageously be used to shell crustaceans, particularly prawns, imperial prawns or the like, at home or in a restaurant.

In a preferred embodiment, the tool may comprise: a base element having a seat for inserting and blocking the crustacean; a slider slidably coupled with said base element for sliding along a first predetermined direction; said slider comprising cutting means susceptible to interact with the crustacean blocked in said seat for cutting the shell thereof during the sliding of the slider along said first direction; wherein said cutting means comprise one or more cutting elements, preferably wedge-shaped, extending downwardly from said slider to face said seat during the sliding along said first direction; said base element comprising a box-like body defining a chamber for collecting the scraps of the cut crustacean and a guide element coupable therewith, preferably at the top of the box-like body, having a first aperture, preferably substantially triangular-shaped, preferably in central position, said cutting elements being disposed along the lower surface of said slider in order to define a shape complementary to which of said first opening.

In a further preferred embodiment, the tool may comprise: a base element having a seat for inserting and blocking the crustacean; a slider slidably coupled with said base element for sliding along a first predetermined direction; said slider comprising cutting means comprising a plurality of cutting elements, preferably wedge-shaped, susceptible to interact with the crustacean blocked in said seat for cutting the shell thereof during the sliding of the slider along said first direction; wherein said slider comprises extraction means susceptible to interact with the crustacean blocked in said seat for extracting the meat from the cut shell thereof; wherein said extraction means comprise a needle susceptible to run through the meat of said crustacean with a free end which is in such a reciprocal spaced relationship with said cutting means that during the sliding of the slider along said first direction said free end run through the meat of the crustacean in correspondence of parts of shell already cut by the first cutting element of said plurality of cutting elements.

In a further aspect, an industrial line for working crustaceans is provided, which includes an inlet for the crustaceans to be worked, an outlet for the worked crustaceans and a station for shelling the crustaceans interposed therebetween.

The peeling station comprises one or more tools having one or more of the features disclosed in the present document.

Advantageous embodiments of the invention are defined in accordance with the dependent claims.

### BRIEF DESCRIPTION OF THE DRAWINGS

Further features and advantages of the invention will be more apparent upon reading the detailed description of a preferred, non-exclusive embodiment of a tool according to the invention, which is described as a non-limiting example with the help of the annexed drawings, in which:

FIG. 1 is a perspective global view of the tool 1;

FIG. 2 is a sectional view of the tool 1;

FIG. 3 is a perspective view of the guide element 5 and of the slider 3;

FIG. 4 is a perspective view of the box-like body 4;

FIG. 4a is an enlarged view of some details of the seat 7;

FIGS. 5 and 6 are respectively top and bottom perspective views of the guide element 5;

FIG. 6a is an enlarged perspective view of some details of the guide element 5;

FIGS. 7 and 8 are respectively top and bottom perspective views of the slider 3;

FIG. 8a is a perspective enlarged view of some details of the slider 3;

FIGS. 9 to 14 are sectional views of the tool 1 in operation.

### DETAILED DESCRIPTION OF A PREFERRED EMBODIMENT

Referring to the above figures, the tool 1 may be advantageously used for the hygienic, quick and practical shelling of crustaceans, such as prawns, imperial prawns, langoustines and the like of several sizes.

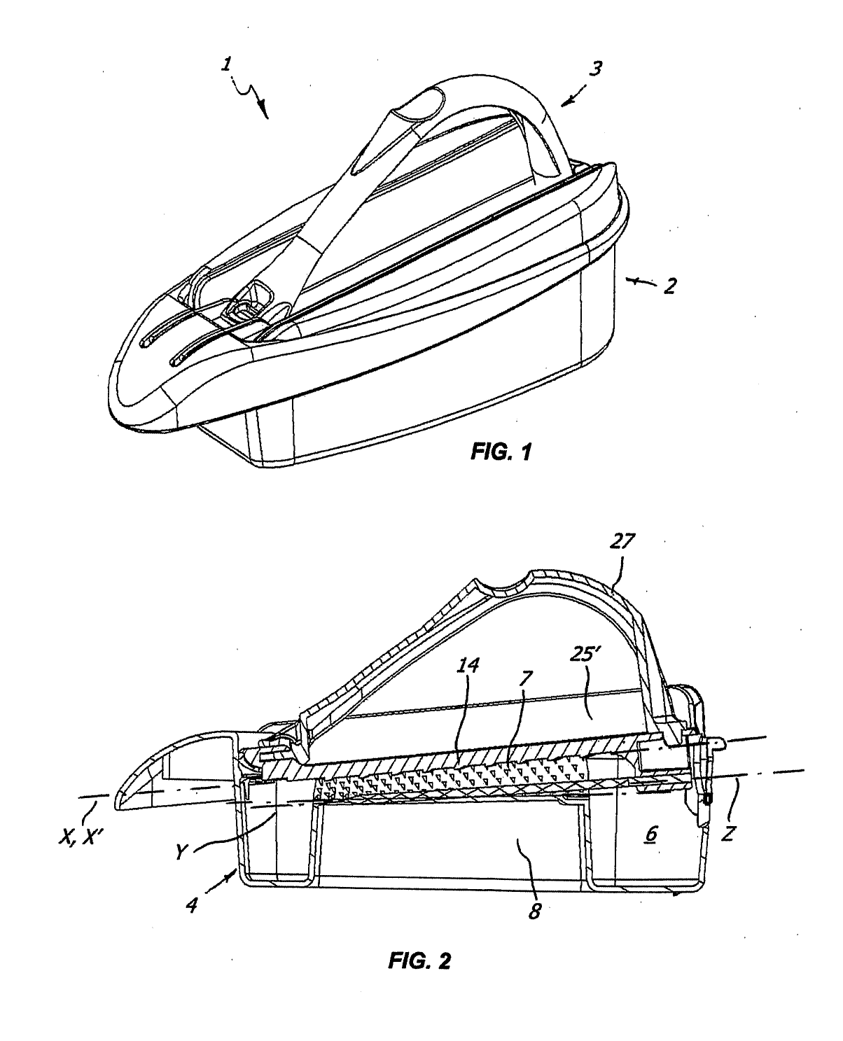

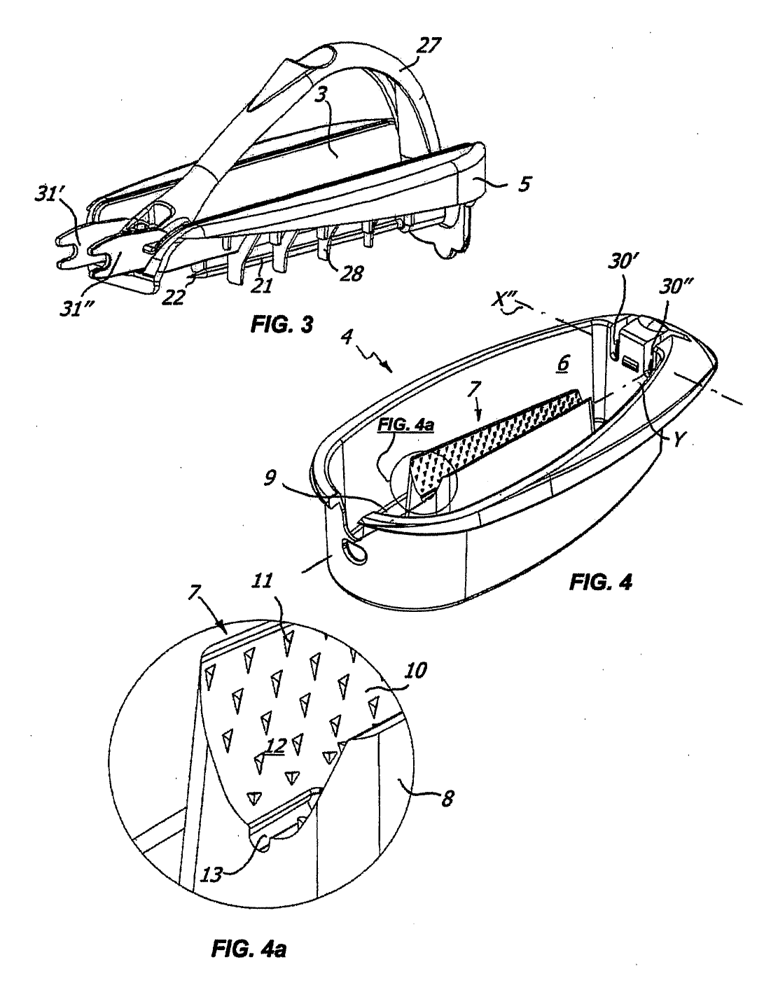

As shown in FIG. 1, the tool 1 may basically comprise a base element 2, which may house the crustacean C, and a cutting slider 3, that slides thereon along a predetermined direction X, for example a longitudinal direction, in such a manner to interact with the crustacean and to cut at least partly the shell thereof during the sliding.

The base element 2 may essentially comprise a box-like body 4 and a guide element 5, the function of which will be better clarified later, which may be removably coupable each other in a per se known manner.

The box-like body 4, which may internally define a collecting chamber 6, may have a seat 7 for inserting and blocking internally thereof the crustacean to be shelled.

In a preferred but not exclusive embodiment of the invention, the seat 7 may consist of a cavity obtained on the top of a central element 8 which upwardly extends from the bottom wall 9 of the collecting chamber 6.

Conveniently, the seat 7 may have an inner surface 10 having an elongated shape for housing the crustacean internally thereof. Preferably, the latter will be placed in the seat 7 with the back part P faced to the inner surface 10 and the front part A turned upwards.

The internal surface 10 of the seat 7 may have a shape converging towards the sense V defined by the sliding of the slider, for example a generally conical shape.

Thus, the crustacean placed in the seat, which tends to slide therein due to the interaction with the slider 3, will reach smaller sections as it slide within the seat 7, until its complete blocking therein. This will also allow the tool to fit all sizes of prawns or like crustaceans.

Further, as particularly shown in FIG. 4a, the seat 7 may have a generally “U” shaped cross section. Preferably, this cross section may have a substantially parabolic profile.

Thus the crustacean, which tends to laterally move and/or rotate in the seat due to the interaction with the slider 3, will tend to lay down on the bottom 12 of the seat, thus automatically centering internally thereof and bringing into line with the cutting means of the slider, which advantageously may be faced to the axis Y defined by the bottom 12 of the seat 7.

Further, the inner surface 10 of seat 7 may preferably include a plurality of knurls 11, which may contribute to oppose the sliding of the crustacean in the seat 7, by firmly fixing it therein, and/or to oppose the lateral movement and/or the rotation of the crustacean in the seat 7.

The seat 7 may further comprise, preferably in correspondence of the largest section of the conical profile, an initial groove 13. This groove, as will be better explained later, is designed to house the head part of the crustacean upon the interaction of the slider 3 therewith. To this end, the slider 3 may comprise means for pushing said head part into the groove 13, preferably defined by a curved guide 16.

In this manner, the cutting means of the slider 3 will begin to work immediately after the head part, which is the hardest part of the crustacean, in order to define a work direction X′ along the front part of the crustacean. For example, if the crustacean is a prawn, this work direction X′ may be defined between the legs of the prawn itself.

Depending on the circumstances, the work direction X′ may or may not be longitudinal, and may or may not be parallel and/or coincident with the sliding direction X of the slider 3.

To this end, the seat 7 and the cutting means of the slider 3 may be mutually spaced and configured to define the cutting direction X′ along the front part of crustacean blocked in the seat 7, that is the part in correspondence of the legs thereof.

Advantageously, in order to optimize the action of the cutting means; the axis Y defined by the bottom 12 of the seat 7 may be suitably inclined with respect to the cutting direction X′.

In a preferred, not-exclusive embodiment, the cutting means of the slider 3 may include a plurality of cutting elements 14, preferably wedge-shaped, downwardly extending from the bottom surface 15 of slider 3, in such a manner to be faced to the seat 7 during the sliding of the slider along the sliding direction X.

Suitably, these wedge-shaped cutting elements 14, having a substantially “V” shape, may be arranged along the bottom surface 15 of the slider 3 to form a triangle, with the first element 14′ which is susceptible to firstly interact with the front part of the crustacean blocked into the seat during the movement of the slider 3 along the direction X.

As particularly shown in FIG. 5, the guide element 5 of the base element 2 includes an opening 17 of generally triangular shape, complementary to that defined by the wedge-shaped cutting elements 14, so that its bottom surface 18 defines the upper wall of the collecting chamber 6.

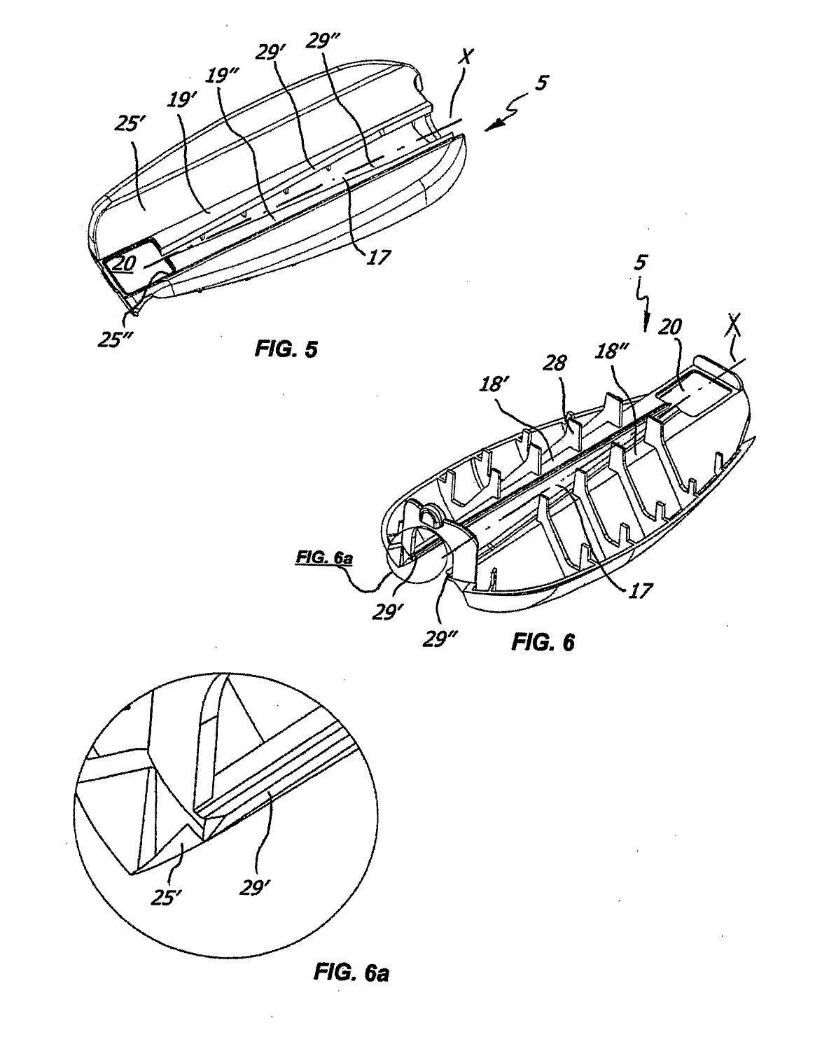

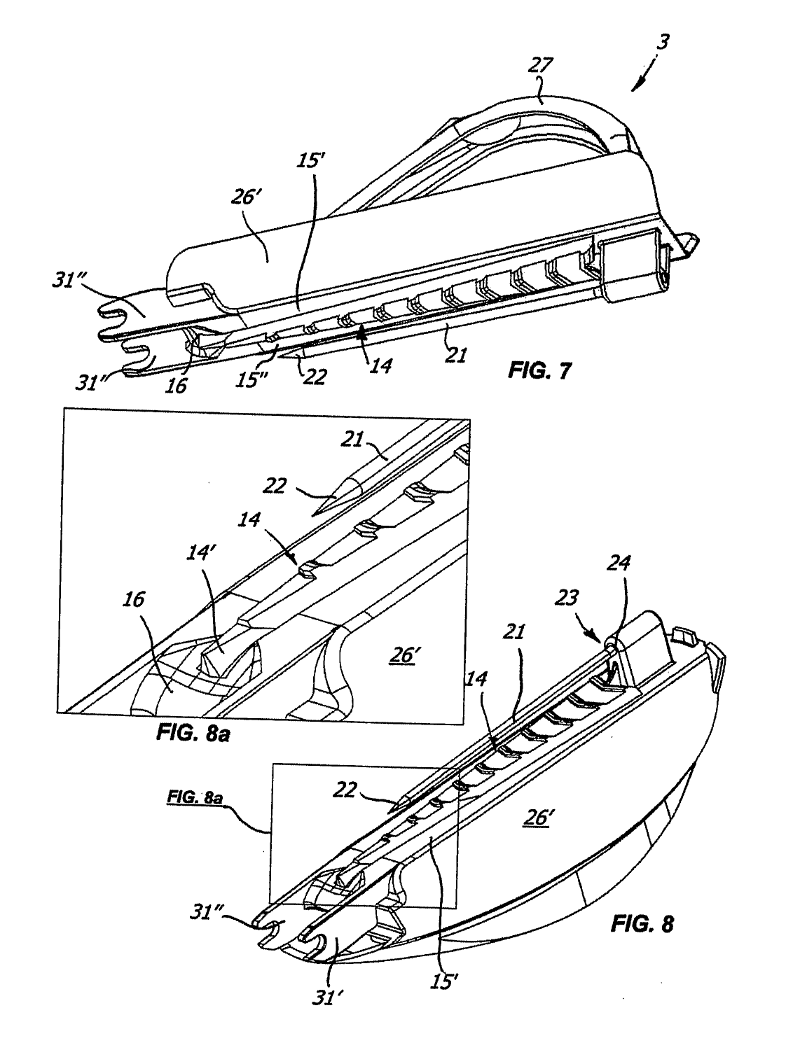

As particularly shown in FIG. 6a, the opening 17 of guide element 5 may include reciprocally faced edges 29′, 29″ directed towards the inside of the body 4 to define blade-like elements with a special “V” section that allow the maintaining of the shell of the crustacean in the seat 7 upon the extraction of pulp M, as will be better clarified later.

On the other hand, the upper surface of the guide element 5 may define inclined plane-like guide means for the sliding of the slider 3. The profile of the upper surface may also define the sliding direction X of the slider 3.

More specifically, in the embodiment shown, the two portions of the upper surface 19′, 19″ may define said inclined plane-like guide means.

The guide element 5 may include means for centering the slider 3, in such a manner that the cutting means 14 will be brought in line with the cutting direction X′.

In a first aspect, these centering means may be defined by the opening 17 which, while interacting with the cutting elements 14, will center the slider 3 during its sliding movement on the inclined plane-like guides 19′, 19″.

In a further aspect, the centering means may be defined by the side walls 25′, 25″, which may be sufficiently spaced apart from each other to laterally constrain with a minimum side clearance the walls 26′, 26″ of the slider 3 during its sliding movement along the direction X.

Upon the sliding of the slider 3 along the direction X, and particularly the sliding of the two portions 15′, 15″ of the bottom surface 15 of the slider 3 on the respective portions 19′, 19″ of the upper surface of the guide element 5 of the base element 2, the cutting elements 14 may collect the shell scraps which may pass into the chamber 6 below by means of a suitable second opening 20.

The latter may be placed at the apex of the triangular opening 17, in such a manner to allow the passage of the collected shell scraps in the collecting chamber 6.

Advantageously, the guide element 5 may further include a plurality of ribs 28 extending downwardly from its bottom surface 18. These ribs 28, which may be suitably shaped, in addition to increase the mechanical properties of the guide element 5, will further define centering means of the latter with respect to the seat 7.

In a preferred but non exclusive embodiment, the slider 3 may comprise a needle 21 susceptible to interact with the crustacean for running through the meat M thereof and extracting it upon the cutting of the shell G by said cutting elements 14.

Suitably, the length of the needle 21 may be such that, during the sliding of the slider 3 along the direction X, its free end 22 run through the meat of the crustacean in correspondence of parts of shell already cut by the first wedge-shaped element 14′.

To this end, for example, the needle 21 may be slightly shorter than the overall length of the triangular element formed by the assembly of the wedge-shaped cutting elements 14.

Further, in order to optimize the extraction action, the needle 21 will extend along a longitudinal direction Z which may be suitably inclined with respect to the cutting direction X′.

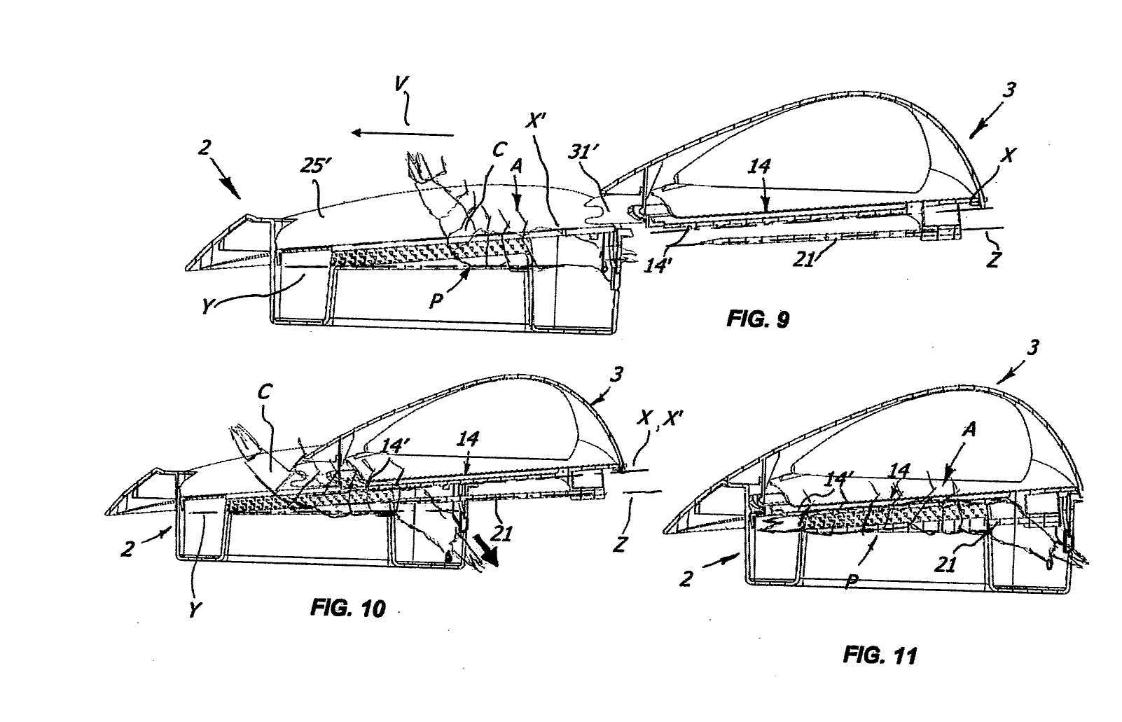

As particularly shown in FIGS. 9 to 14, the tool 1 may be operatively used as follows.

First of all, the base element 2 will be provided, by placing in the seat 7 the crustacean C.

As used herein, the term “provide” and derivatives thereof, designates the preparation of a relevant component for a relevant process step, including any preventive treatment designed for optimal performance of such relevant step, from simple collection and possible storage to thermal and/or chemical and/or physical pre-treatments or the like.

For example, the provision step of the base element 2, as well as the possible providing step of the slider 3, may include the removal of any residue from previous operations, possibly by hands.

After inserting the crustacean into the seat 7, suitably with the back part P faced towards the inner surface 10 thereof and the front part A turned upwards, the slider 3 will be slid on the base 2 along the direction X in the sense V to allow the cutting action of the former on the crustacean.

The crustacean, the head part thereof may be placed in correspondence of the groove 13, during the sliding movement of the slider 3 along the direction X will first impact against the curved guide 16, which will push the head of the crustacean in the groove 13 and will “stretch” the crustacean along the seat 7 during sliding.

If the crustacean is smaller than the seat 7, the interaction with the slider 3 will induce its axially sliding in the seat 7 along the direction Y, until its blocking therein because of the convergent shape of the seat 7 and/or the gripping action of the knurls 11.

Similarly, the “U”-shaped section and/or the knurls 11 of the seat 7 will block the transverse and rotational degrees of freedom of the crustacean C in the seat 7 itself, thus centering it along the direction Y.

During the sliding movement of the slider 3 along the direction X, the cutting means 14, and in particular the first wedge-shape element 14′, will advance along the direction X′, thus cutting the shell G of crustacean blocked into the seat 7 and gradually opening it, in such a manner to favorite the action of the needle 21. At the same time, the free end 22 of the latter will penetrate the meat M of the crustacean C, thus running through it for the subsequent extraction and enlarging of the section of the crustacean, in such a manner to block it even more firmly into the seat 7.

As the cutting means 14 advance, they may collect shell scraps, which will fall down into the collecting chamber 6 through the opening 20.

In order to allow a good extraction action of the meat M from the crustaceans so shelled, end-stroke means for the slider 3 may be provided.

In a preferred but not exclusive embodiment of the invention, such end-stroke means may further include hinge means, preferably having one pair of pins 30′, 30″ of said base element 2 engageable with a respective couple of pivot elements 31′, 31″ of said slider 3, the latter being susceptible to rotate on the former about a transverse axis X″ defined thereby.

These hinge means, besides limiting the sliding of the slider 3, will allow the rotation of the latter around the axis X″ in the sense of the arrow R, so as to allow the extraction operation.

At this moment, the blade-like edges 29′, 29″ will also cooperate for optimizing the extraction operation by allowing the maintaining of the shell G of the crustacean C into the seat 7 upon the rotation of the slider 3 around the axis X″; in such a manner to allow the solidal rotation of the needle 21 with the slider and the easy extraction of the pulp M.

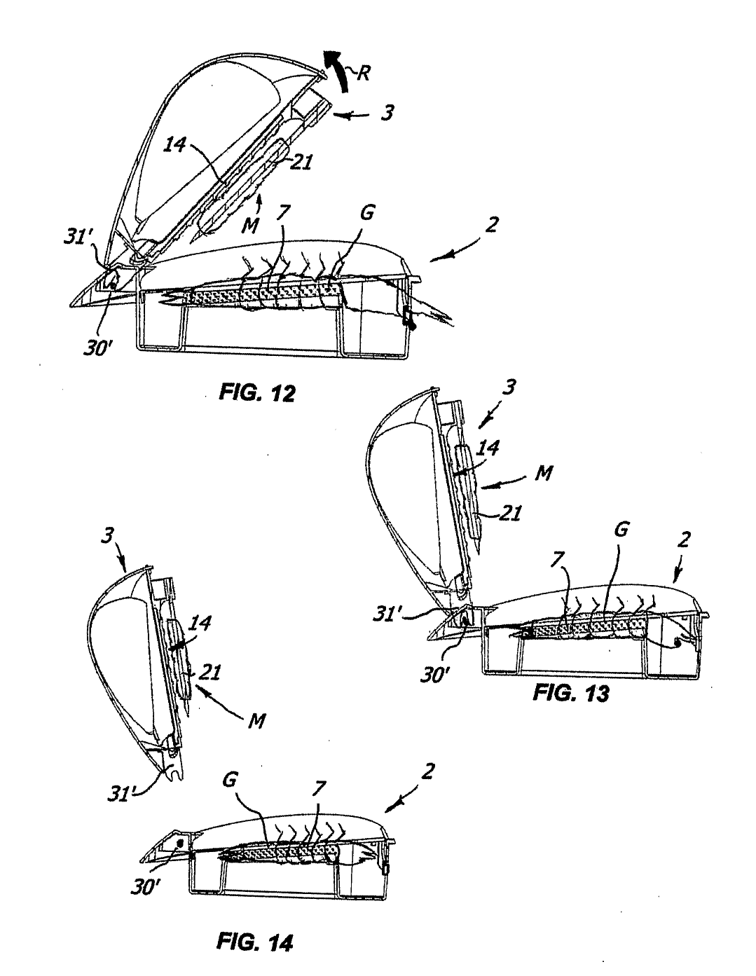

The rotation of the slider 3 around the axis X″ will further allow the easy removal thereof from the base element 2 and the possible taking of the meat of the prawn off the needle 21, as particularly shown in FIGS. 12 to 14.

Furthermore, to this end, the latter can be mounted in a removable manner on the slider 3. For example, the end 23 of needle 21 may be removably insertable in a suitable countershaped seat 24.

In a preferred but not exclusive embodiment, the slider 3 and the base element 2 may be reciprocally moved by hands, and to this end a handle 27 may be provided in order to simplify this operation.

On the other hand, in order to reciprocally move the slider 3 and the base element 2, suitable motor means may be provided, preferably associated to the same tool, not represented in figures because known per se.

The tool 1 may advantageously be used for shelling crustaceans, particularly prawns, imperial prawns or the like, at home or in a restaurant. On the other hand, the tool 1, which may include one or more of the above features, may be part of a crustaceans industrial shelling station, which may in turn be implemented in an industrial line for working crustaceans.

The above disclosure clearly shows that the invention fulfils the intended objects, and particularly the object of providing a tool that allows a quick and practical shelling of crustaceans; without touching the crustaceans by hands and without getting dirty.

The tool of this invention is susceptible of a number of changes and variants, all within the inventive concept disclosed in the appended claims. All the details thereof may be replaced by other technically equivalent parts, and the materials may vary depending on different needs, without departure from the scope of the invention.

The invention claimed is:

1.-23. (canceled)

24. A tool for shelling crustaceans comprising:
a base element having a seat for inserting and blocking a crustacean; and
a slider slidably coupled with the base element and configured for sliding along a first direction, the slider comprising a plurality of cutting members extending downwardly therefrom to face the seat, so as to interact with the crustacean blocked into the seat for cutting the shell thereof during the sliding of the slider along the first direction,
wherein the base element comprises a box-shaped body and a guide element designed to be coupled therewith, which includes a first opening cooperating with the cutting members for guiding and centering the slider during the cutting of the shell, and
wherein the box-shaped body includes a chamber for collecting scraps of the cut crustacean, the guide element further comprising a second opening to collect the scraps cut by the cutting members during the sliding of the slider along the first direction and to allow passage thereof into the chamber.

25. The tool according to claim 24, wherein the seat includes a substantially U-shaped internal surface converging where defined by the sliding along the first direction.

26. The tool according to claim 25, wherein the internal surface includes a plurality of knurls for engaging the shell of the crustacean.

27. The tool according to claim 25, wherein the internal surface of the seat is designed to receive a back part of the crustacean, the seat and the cutting element being in such a reciprocal spaced relationship to define a cutting direction along a front part of the crustacean blocked in the seat.

28. The tool according to claim 24, wherein the seat comprises a portion defining a groove, the slider comprising a protruding portion for interacting with the head of the crustacean and for pushing it into the groove to optimize action of the cutting element.

29. The tool according to claim 24, wherein the cutting members are substantially wedge-shaped.

30. The tool according to claim 24, wherein the first opening defines the first sliding direction of the slider.

31. The tool according to claim 24, wherein the first opening has a shape converging where defined by the sliding along the first direction, the cutting members having a shape complementary to that of the first opening.

32. The tool according to claim 24, wherein the guide element is designed to be coupled with the box-shaped body at a top thereof.

33. The tool according to claim 24, wherein the slider has two lower surfaces, the guide element comprising a couple of corresponding upper inclined plane-shaped surfaces designed to cooperate with the two lower surfaces of the slider for guiding the sliding thereof, the inclined plane-shaped guiding surfaces defining the first direction.

34. The tool according to claim 33, wherein the first opening is interposed between the inclined plane-shaped guiding surfaces, the first sliding direction being not incident with a sliding plane defined by the inclined plane-shaped guiding surfaces.

35. The tool according to claim 24, wherein the first opening of the guide element comprises reciprocally faced edges directed toward the collecting chamber.

36. The tool according to claim 24, wherein the slider includes an extraction needle designed to run through meat of the crustacean blocked in the seat for extraction thereof from the cut shell, the needle having a free end which is in a reciprocal spaced relationship with the cutting members such that during the sliding of the slider along the first direction the free end runs through the meat of the crustacean in correspondence of shell parts already cut by a first element of the plurality of cutting elements.

37. The tool according to claim 24, wherein the base element comprises a hinge member designed to block the sliding of the slider and allowing rotation of the slider along a predetermined transverse axis.

38. The tool according to the claim 37, wherein the hinge member comprises one pair of pins of the base element defining the transverse axis designed to be engaged with one respective pair of pivot elements of the slider for rotating about the transverse axis.

39. An industrial line for working prawns or like crustaceans, comprising:
an inlet for crustaceans to be worked;
an outlet for the worked crustaceans; and
a station for shelling the crustaceans interposed between the inlet and the outlet, wherein the shelling station comprises at least one tool for shelling prawn or like crustaceans, the at least one tool comprising,
a base element having a seat for inserting and blocking a crustacean, and
a slider slidably coupled with the base element for sliding along a first direction, the slider comprising a plurality of cutting members extending downwardly therefrom to face the seat, so as to interact with the crustacean blocked in the seat for cutting a shell thereof during the sliding of the slider along the first direction,
wherein the base element comprises a box-like body and a guide element designed to be coupled therewith which includes a first opening cooperating with the cutting members for guiding and centering the slider during the cutting of the shell, and
wherein the box-like body includes a chamber for collecting scraps of the cut crustacean, the guide element further comprising a second opening to collect the scraps cut by the cutting members during the sliding of the slider along the first direction and to allow passage thereof into the chamber.
